(19) United States
(12) Patent Application Publication
(10) Pub. No.: US 2014/0339040 A1
(43) Pub. Date: Nov. 20, 2014

(54) INSULATING SECTION, POWER SUPPLY RAIL, AND ORBITAL TRANSPORTATION SYSTEM

(71) Applicant: MITSUBISHI HEAVY INDUSTRIES, LTD., Tokyo (JP)

(72) Inventors: Yasuyuki Mukai, Tokyo (JP); Toshiaki Asanoma, Tokyo (JP)

(21) Appl. No.: 14/372,069

(22) PCT Filed: Feb. 1, 2013
(86) PCT No.: PCT/JP2013/052361

§ 371 Date: Jul. 14, 2014

(30) Foreign Application Priority Data
Feb. 2, 2012 (JP) 2012-021171

(51) Int. Cl. B60M 1/30

(52) U.S. Cl. CPC B60M 1/30
USPC 191/29 R

(57) ABSTRACT

This insulating section is an insulating section that extends to a side of a vehicle and connects train lines, which are in contact with a pantograph of the vehicle, to each other on a contact surface facing the vehicle. The contact surface has a groove formed from the upper edge to the lower edge in a vertical direction perpendicular to a traveling direction. The groove is formed such that the cross-section in the vertical direction becomes a part of the contact surface in the vertical direction at any position in the traveling direction.

### Technical Field

The present invention relates to a power supply rail for supplying electric power from the train lines located on lateral sides with respect to a vehicle.

Priority is claimed on Japanese Patent Application No. 2012-021171, filed Feb. 2, 2012, the content of which is incorporated herein by reference.

### BACKGROUND ART

As new transportation means for replacing a bus or a train, an orbital transportation system is known in which a vehicle travels on a track with traveling wheels, which are formed of rubber tires, and guide wheels provided in both side portions or a lower portion of the vehicle are guided by guide rails provided in both side portions or the center of the track. Such an orbital transportation system is generally called a new transportation system or an automated people mover (APM).

A power supply rail is provided in a side portion of the track of the orbital transportation system described above. A pantograph provided in a side portion of the vehicle is slidably in contact with the power supply rail in a state facing the power supply rail, thereby supplying electric power to the vehicle.

In the power supply rail, an insulating section that is in an insulating state is provided between the train lines electrically connected to a feeder, as a separator of a feeding section, every hundreds of meters. In general, compressed wood is used for the insulating section. However, since a pantograph is slidably in contact with the insulating section like the train lines are, deterioration, such as abrasion or dents, occurs fast, and the replacement frequency is increased. For this reason, materials to replace the compressed wood have been studied.

For example, in NPL 1, FRP that is a material with higher abrasion resistance than that of the compressed wood is used for the insulating section in order to improve durability. Carbon of the pantograph adheres to the contact surface of the FRP easily, compared with the compressed wood. However, the occurrence of a conduction state in the traveling direction due to carbon adhesion is prevented by forming a groove, which is notched upward from the contact surface and extends in the track width direction perpendicular to the traveling direction of the vehicle, in the insulating section.

### CITATION LIST

### Non Patent Literature

[NPL 1] Junya Noguchi, Yasuhisa Abe, “Development of FRP section insulator cutting machine”, [edited by] Railway and Electrical Technology/Railway Electrical Engineering Association of Japan, June 1999, 10 (6) (No. 614), p. 44-47

### SUMMARY OF INVENTION

### Technical Problem

However, the insulating section disclosed in NPL 1 is applied when a cable is provided above a vehicle and a current collector (pantograph) is in contact with the cable from below.

Compared with a case where electric power is supplied from the overhead cable as disclosed in NPL 1, in an orbital transportation system in which electric power is supplied to the vehicle from the power supply rail on the side, bending or the like occurs in the power supply rail. Accordingly, it is not easy for the vehicle to travel while maintaining a sliding contact state so that the current collector follows the shape of the power supply rail. For this reason, the current collector in the orbital transportation system or the like can rotate with a vertical direction, which is perpendicular to the traveling direction and the track width direction of the vehicle, as the axis, so that the sliding contact state can be maintained corresponding to the shape of the power supply rail. Specifically, as shown in FIGS. 5A and 5B, a current collector 51 rotates around the axis P to correspond to the linearity of a power supply rail 50, thereby maintaining the sliding contact state.

In the orbital transportation system, a mechanism for rotating the current collector 51 as described above is adopted. Therefore, when the insulating section in which a groove is formed as disclosed in NPL 1 is applied to the orbital transportation system as it is, the edge of the current collector 51 may be caught in a groove 52 as shown in FIG. 5C. As a result, an impact may occur to lower the riding quality.

The present invention provides an insulating section, a power supply rail, and an orbital transportation system capable of improving the riding quality while realizing reliable insulation.

### Solution to Problem

(1) According to a first aspect of the present invention, an insulating section is an insulating section that extends to a side of a vehicle and connects train lines, which are in contact with a current collector of the vehicle, to each other on a contact surface facing the vehicle. The contact surface has a groove formed from an upper edge to a lower edge in a vertical direction perpendicular to an extending direction of the insulating section. The groove is formed such that a cross-section in the vertical direction becomes a part of the contact surface in the vertical direction at any position in the extending direction.

According to the insulating section, a groove is formed. Therefore, even if carbon or the like adheres when a vehicle travels in a state where the current collector is in contact with the contact surface, the continuity of the contact surface is interrupted by the groove. As a result, it is possible to avoid the occurrence of a conduction state. In addition, at any position in the extending direction in which the groove is formed, the current collector is in contact with a part of the contact surface. In this case, the edge of the current collector is not located in the groove throughout the vertical direction. Therefore, even if the width of the groove in the extending direction is set to be large so that the conduction state can be reliably avoided, it is possible to prevent the current collector from being caught in the groove and causing an impact.

(2) In the insulating section described in (1), the groove may be formed so as to be inclined from one side toward the other side in the vertical direction as movement from one side toward the other side in the extending direction is made.

By forming the groove so as to be inclined as described above, it is possible to avoid a conduction state. In addition, since the edge of the current collector is not located in the groove throughout the vertical direction, it is possible to prevent the current collector from being caught in the groove and causing an impact. Therefore, it is possible to improve the riding quality of the vehicle.

(3) In the insulating section described in (1), the groove may be formed so as to be curved from one side toward the other side in the vertical direction as movement from one side toward the other side in the extending direction is made.

By using the groove, it is possible to avoid the conduction state reliably and to prevent the occurrence of an impact due to the current collector being caught. Therefore, it is possible to improve the riding quality of the vehicle.

(4) In the insulating section described in (1) to (3), the contact surface may have first and second contact surfaces provided with a gap therebetween in the vertical direction, and the groove may be formed at different positions in the extending direction on the first and second contact surfaces.

By using the groove, it is possible to avoid the conduction state reliably and to prevent the occurrence of an impact due to the current collector being caught. Therefore, it is possible to improve the riding quality of the vehicle.

(5) According to a second aspect of the present invention, a power supply rail includes: train lines in contact with a current collector of a vehicle; and the insulating section connecting the train lines to each other that is described in any one of (1) to (4).

According to the power supply rail, it is possible to avoid the conduction state reliably by the insulating section and to prevent the occurrence of an impact due to the current collector being caught. Therefore, it is possible to improve the riding quality of the vehicle.

(6) According to a third aspect of the present invention, an orbital transportation system includes the insulating section described in any one of (1) to (4) or the power supply rail described in (5).

According to the orbital transportation system, it is possible to avoid the conduction state reliably by the insulating section and to prevent the occurrence of an impact due to the current collector being caught. Therefore, it is possible to improve the riding quality of the vehicle.

### Advantageous Effects of Invention

According to the insulating section, the power supply rail, and the orbital transportation system of the respective aspects of the present invention, it is possible to improve the riding quality while realizing reliable insulation with a groove.

### BRIEF DESCRIPTION OF DRAWINGS

FIG. 1 is an overall schematic diagram when an orbital transportation system according to a first embodiment of the present invention is viewed from the traveling direction of a vehicle.

FIG. 2A is a side view showing a power supply rail in the orbital transportation system according to the first embodiment of the present invention.

FIG. 2B is a diagram viewed from the arrow A in FIG. 2A.

FIG. 2C is a cross-sectional view taken along the line B-B in FIG. 2A.

FIG. 3 is a side view showing a first modification of the power supply rail in the first embodiment of the present invention.

FIG. 4 is a side view showing a second modification of the power supply rail in the first embodiment of the present invention.

FIG. 5A is a top view showing an operating state of a pantograph in the orbital transportation system of the present invention.

FIG. 5B is a top view showing an operating state of a pantograph in the orbital transportation system of the present invention.

FIG. 5C is a top view showing an operating state of a pantograph in the orbital transportation system of the present invention.

### DESCRIPTION OF EMBODIMENTS

Hereinafter, an orbital transportation system 1 according to a first embodiment of the present invention will be described.

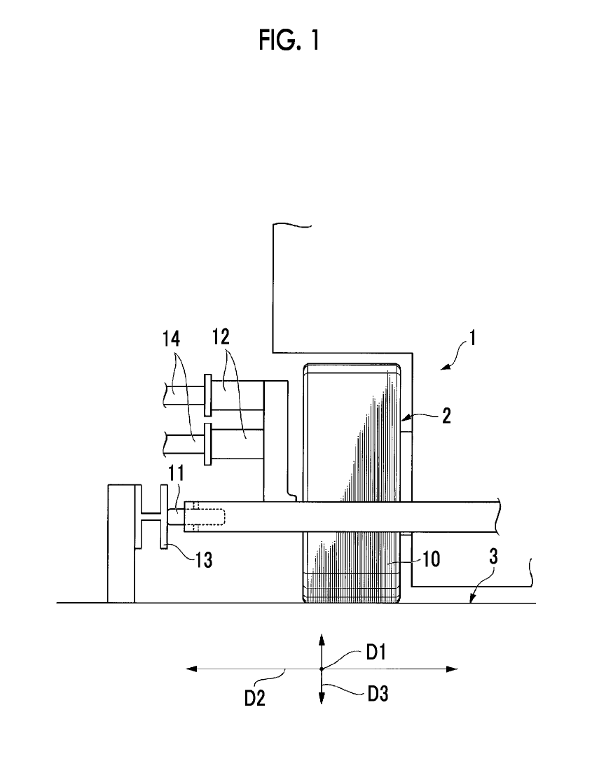

As shown in FIG. 1, the orbital transportation system 1 is a new transportation system based on a side guide method in which a vehicle 2 travels on a track 3 while being guided on the side.

The vehicle 2 includes: a traveling wheel 10 provided so as to be able to roll on the track 3; a guide wheel 11 that is disposed on the outer side in a width direction D2 perpendicular to a traveling direction D1 than the traveling wheel 10 is and that can rotate with a vertical direction D3 perpendicular to the traveling direction D1 and the width direction D2 as an axis; and two pantographs (current collectors) 12 provided above the guide wheel 11 with a gap therebetween in the vertical direction D3.

The track 3 includes a guide rail 13, which faces the guide wheel 11 and guides the vehicle 2 along the traveling direction D1, and two power supply rails 14, which are provided along the traveling direction D1 above the guide rail 13 with a gap therebetween in the vertical direction D3 and which are provided so as to be slidably in contact with the two pantographs 12.

Next, the power supply rail 14 will be described.

The power supply rails 14 are provided along the traveling direction D1 with a gap therebetween in the vertical direction D3 at the sides of the track 3.

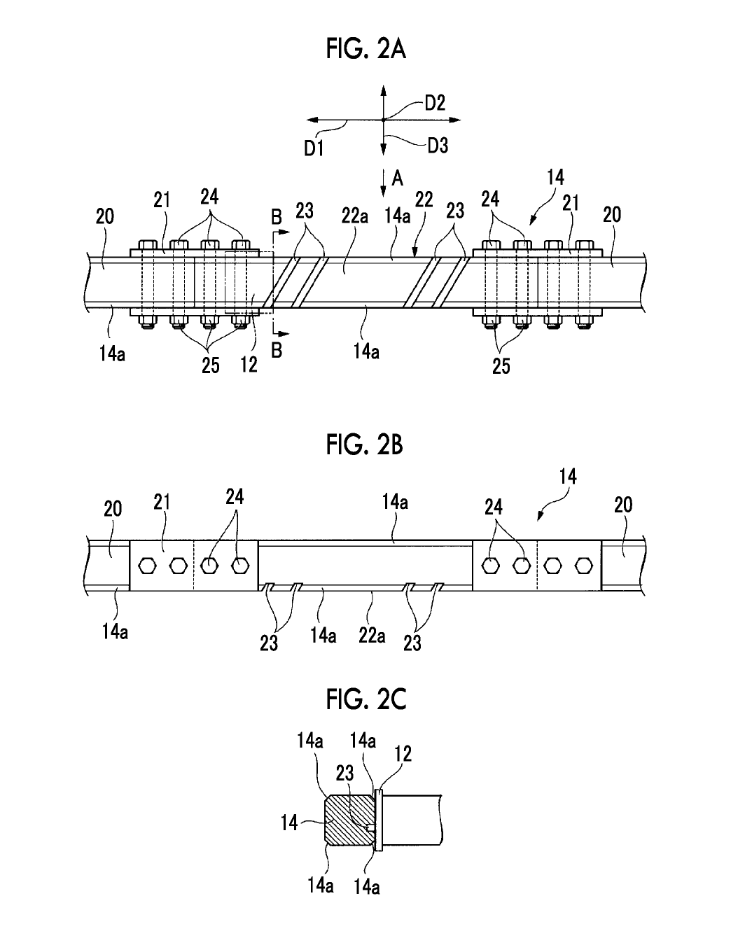

As shown in FIGS. 2A to 2C, each power supply rail 14 includes train lines 20, which are electrically connected to a feeder (not shown) and are disposed with a gap therebetween in the traveling direction D1, and an insulating section 22, which is disposed between the train lines 20 and is connected to the train lines 20 by a connection plate 21.

As shown in FIG. 2C, the cross-sectional shape of the power supply rail 14 in the vertical direction D3 is an octagonal shape with a chamfered portion 14a formed by chamfering the corner.

The train line 20 is disposed along the traveling direction D1, and electric power is supplied through the feeder from a feeding section (not shown). The train line 20 is provided so as to be slidably in contact with the pantograph 12, so that electric power is supplied to the vehicle 2.

The insulating section 22 is formed of a non-conductive material, such as FRP, and is disposed between the train lines 20, which are adjacent to each other in the traveling direction D1, along the traveling direction D1. The insulating section 22 has a groove 23 that is notched outward in the width direction D2 from a contact surface 22a in contact with the pantograph 12. In the present embodiment, two grooves 23 are formed at each of both ends in the traveling direction D1 with a gap therebetween in the traveling direction D1.

As shown in FIG. 2A, each groove 23 is formed between the upper and lower edges of the contact surface 22a so as to be inclined from the lower side (one side) toward the upper side (the other side) in the vertical direction D3 as the position moves from the front side (one side) toward the rear side (the other side) in the traveling direction (extending direction) D1.

As shown in FIG. 2B, when the insulating section 22 is viewed from the vertical direction D3, the groove 23 is inclined from the inside toward the outside in the width direction D2 as the position moves from the front side toward the rear side in the traveling direction D1, and is formed up to a position beyond the chamfered portion 14a that is a middle position in the width direction D2.

The connection plate 21 is fixed by a bolt 24 and a nut 25 with the train lines 20, which are adjacent to each other in the traveling direction D1, and the insulating section 22, which is disposed between the train lines 20, interposed from the vertical direction D3.

In such an orbital transportation system 1, the vehicle 2 travels on the track 3 in a state where the pantograph 12 of the vehicle 2 is slidably in contact with the power supply rail 14. As the insulating section 22, FRP is adopted. Therefore, compared with compressed wood or the like, deterioration due to abrasion is small even if repetitive sliding occurs. As a result, durability can be improved.

When the carbon of the pantograph 12 adheres to the contact surface 22a of the insulating section 22 due to repeating the sliding as described above, a situation where the continuity between the train line 20 and the insulating section 22 is interrupted and the train lines 20 adjacent to each other are electrically connected to each other can be avoided due to the groove 23 formed on the contact surface 22a.

In addition, in order to avoid a situation where the carbon enters the groove 23 to block the groove 23 and accordingly a conduction state occurs, it is necessary to set the width of the groove 23 in the traveling direction D1 to be large to some extent. In this respect, even if the width of the groove 23 in the traveling direction D1 is set to be large, the pantograph 12 is necessarily in contact with a part of the contact surface 22a at any position in the traveling direction D1 where the groove 23 is formed since the groove 23 is inclined in the present embodiment. That is, the edge of the pantograph 12 in the traveling direction D1 is not located in the groove 23 throughout the vertical direction D3. Therefore, it is possible to prevent the pantograph 12 from being caught in the groove 23 and causing an impact. In addition, it is also possible to prevent the abrasion of the pantograph 12 or damage to the pantograph 12 caused by such impact.

Two grooves 23 are provided at each of both ends of the insulating section 22 in the traveling direction D1. Accordingly, even if one groove is blocked by carbon and causes a conduction state, it is possible to maintain the insulating state by the other groove. That is, since it is possible to achieve redundancy, it is possible to improve the reliability.

According to the orbital transportation system 1 of the present embodiment, electrical connection between the train lines 20 due to the carbon of the pantograph 12 can be avoided due to the groove 23 of the insulating section 22. Therefore, since it is possible to maintain the insulating state reliably and to prevent the occurrence of an impact when the edge of the pantograph 12 is located in the groove 23, it is possible to improve the riding quality.

According to the orbital transportation system 1 of the present embodiment, it is possible to improve the reliability by preventing the abrasion of the pantograph 12 or by ensuring the redundancy of the insulating section 22.

In the present embodiment, the groove 23 is formed so as to be inclined from the lower side toward the upper side in the vertical direction D3 as the position moves from the front side toward the rear side in the traveling direction D1. However, the groove 23 may be formed so as to be inclined from the upper side toward the lower side in the vertical direction D3 as the position moves from the front side toward the rear side in the traveling direction D1 on the contrary.

The respective grooves 23 may also be provided so as to be inclined in different directions.

In addition, the shape of the groove 23 when the insulating section 22 is viewed from the vertical direction D3 may be any shape. For example, the shape of the groove 23 when the insulating section 22 is viewed from the vertical direction D3 may be tapered toward the outside in the width direction D2, or may be formed straight toward the outside in the width direction D2 without inclination in the traveling direction D1.

Next, the orbital transportation system 1 according to a second embodiment will be described.

In addition, the same components as in the first embodiment are denoted by the same reference numerals, and detailed explanation thereof will be omitted.

A power supply rail 31 of the present embodiment has a configuration obtained by providing an insulating section 32 in the power supply rail 14 of the first embodiment instead of the insulating section 22. That is, the configuration of the power supply rail 31 other than the insulating section is the same as that of the power supply rail 14. In the insulating section 32 of the power supply rail 31, the shape of the groove 33 is different from that in the first embodiment, and the other configurations are the same as the insulating section 22.

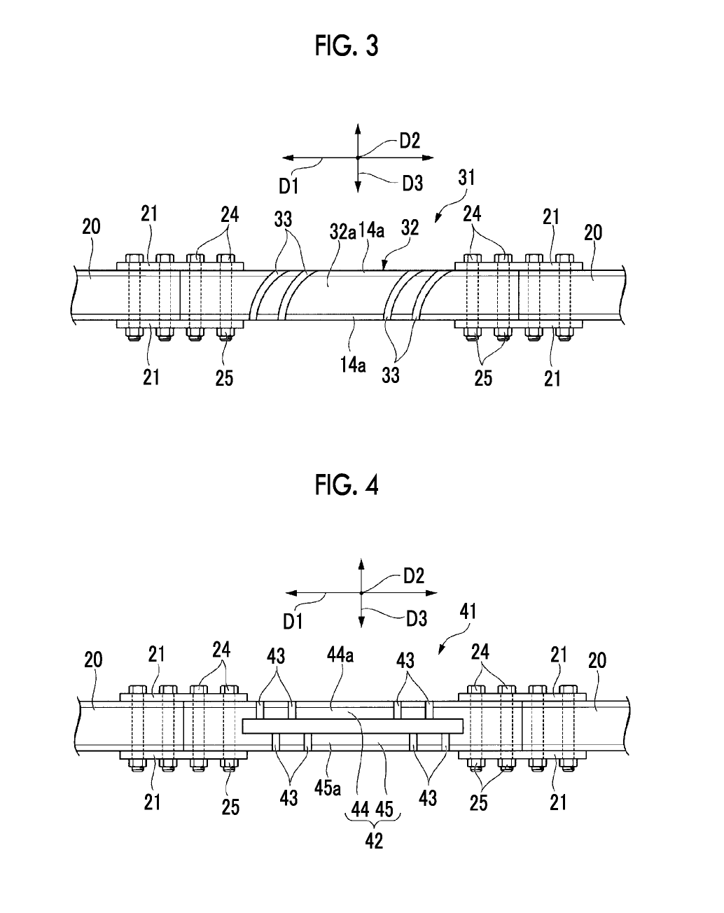

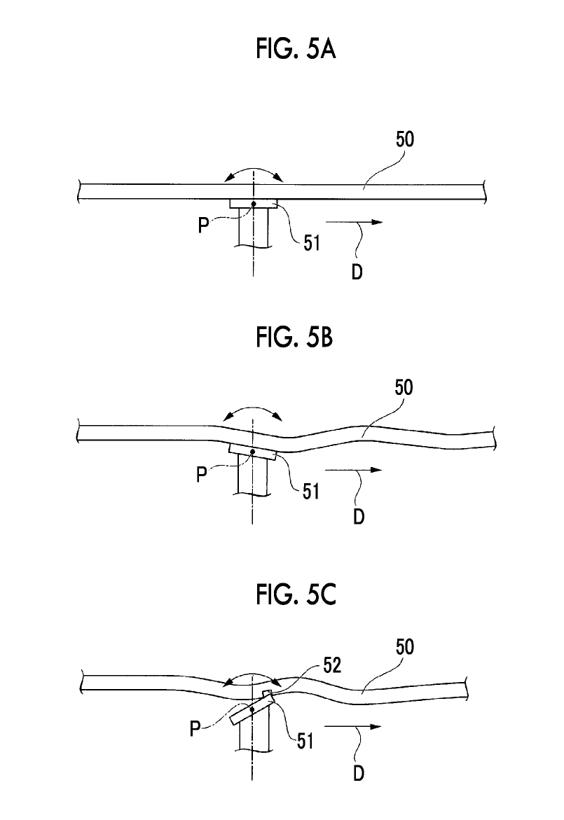

As shown in FIG. 3A, the groove 33 is formed between the upper and lower edges of the contact surface so as to be curved from the lower side (one side) toward the upper side (the other side) in the vertical direction D3 as the position moves from the front side (one side) toward the rear side (the other side) in the traveling direction (extending direction) D1.

Two grooves 33 are formed at each of both ends of the insulating section 32 in the traveling direction D1 with a gap therebetween in the traveling direction D1. The configuration of the groove 33 viewed from the vertical direction D3 may be the same as that of the groove 23 of the insulating section 22 in the first embodiment.

In the orbital transportation system 1 that uses the power supply rail 31, even if the carbon of the pantograph 12 adheres to a contact surface 32a of the insulating section 32, a situation where the continuity between the train line 20 and the insulating section 32 is interrupted and the train lines 20 adjacent to each other are electrically connected to each other can be avoided due to the groove 33 formed on the contact surface 32a. The pantograph 12 is necessarily in contact with a part of the contact surface 32a. That is, since the edge of the pantograph 12 in the traveling direction D1 is not located in the groove 33 throughout the vertical direction D3, it is possible to prevent the pantograph 12 from being caught in the groove 33 and causing an impact. As a result, it is also possible to prevent the abrasion of the pantograph 12 or damage to the pantograph 12 caused by such impact.

According to the orbital transportation system 1 that uses the power supply rail 31 of the present embodiment, it is possible to maintain the insulating state reliably and to prevent the occurrence of an impact on the pantograph 12 due to the groove 33 of the insulating section 32. Therefore, it is possible to improve the riding quality.

In the present embodiment, the groove 33 is formed so as to be curved from the lower side toward the upper side in the vertical direction D3 as the position moves from the front side toward the rear side in the traveling direction D1. However, conversely, the groove 33 may be formed so as to be curved from the upper side toward the lower side in the vertical direction D3 as the position moves from the front side toward the rear side in the traveling direction D1.

The respective grooves 33 may also be provided so as to be curved in different directions. In this case, it is possible to further reduce the impact on the pantograph 12.

Next, the orbital transportation system 1 according to a third embodiment will be described.

In addition, the same components as in the first and second embodiments are denoted by the same reference numerals, and detailed explanation thereof will be omitted.

In the present embodiment, the configuration of an insulating section 42 in a power supply rail 41 is different from that in the first and second embodiments.

A power supply rail 41 of the present embodiment has a configuration obtained by providing the insulating section 42 instead of the insulating section 22 in the power supply rail 14 of the first embodiment. That is, the configuration of the power supply rail 41 other than the insulating section is the same as that of the power supply rail 14.

As shown in FIG. 4, the insulating section 42 is formed of a non-conductive material, such as FRP, as in the first and second embodiments. The insulating section 42 is disposed between the train lines 20, which are adjacent to each other in the traveling direction D1, along the traveling direction D1. The insulating section 42 includes first and second insulating portions 44 and 45, which are disposed with a gap therebetween in the vertical direction D3, for each power supply rail 41.

At each of both ends of the first insulating portion 44 in the traveling direction D1, two grooves 43, which are notched from the upper edge to the lower edge of a first contact surface 44a in the vertical direction D3, are provided from the first contact surface 44a in contact with the pantograph 12 toward the outside in the width direction D2 with a gap therebetween in the traveling direction D1.

Similar to the first insulating portion 44, at each of both ends of the second insulating portion 45 in the traveling direction D1, two grooves 43, which are notched from the upper edge to the lower edge of a second contact surface 45a in the vertical direction D3, are provided from the second contact surface 45a in contact with the pantograph 12 toward the outside in the width direction D2 with a gap therebetween in the traveling direction D1. The configuration of the groove 43 viewed from the vertical direction D3 may be the same as that of the groove 23 of the insulating section 22 in the first embodiment.

The groove 43 of the first insulating portion 44 and the groove 43 of the second insulating portion 45 may be formed so as not to be disposed at the same position in the traveling direction D1 by positional deviation.

In the orbital transportation system 1 that uses the power supply rail 41, even if the carbon of the pantograph 12 adheres to the first and second contact surfaces 44a and 45a of the insulating section 42, a situation where the continuity between the train line 20 and the insulating section 42 is interrupted and the train lines 20 adjacent to each other are electrically connected to each other can be avoided due to the groove 43 formed on the first and second contact surfaces 44a and 45a.

In addition, the groove 43 is formed on each of the first and second contact surfaces 44a and 45a by providing a gap between the first and second insulating portions 44 and 45 and performing a positional deviation in the vertical direction D3. Accordingly, the pantograph 12 is necessarily in contact with a part of the first and second contact surfaces 44a and 45a. That is, since the edge of the pantograph 12 in the traveling direction D1 is not located in the groove 43 throughout the vertical direction D3, it is possible to prevent the pantograph 12 from being caught in the groove 43 and causing an impact. As a result, it is also possible to prevent the abrasion of the pantograph 12 or damage to the pantograph 12 caused by such impact.

According to the orbital transportation system 1 of the present embodiment, it is possible to maintain the insulating state reliably and to prevent the occurrence of an impact on the pantograph 12 due to the groove 43 of the insulating section 42. Therefore, it is possible to improve the riding quality. In the embodiment described above, the first and second insulating portions 44 and 45 are formed of the same member. However, a portion including the first insulating portion 44 and a portion including the second insulating portion 45 may be formed of different members. In this case, since the first and second insulating portions 44 and 45 are independent, facilitating the replacement work can also be expected.

In addition, each groove 43 formed on the first and second contact surfaces 44a and 45a may be formed so as to be inclined as in the first embodiment, or may be formed so as to be curved as in the second embodiment.

In such a case, since it is possible to prevent the occurrence of an impact on the pantograph 12, it is possible to improve the riding quality.

While the embodiments of the present invention have been described in detail, some design changes are possible within a range not departing from the spirit of the present invention.

For example, the edge of each of the grooves 23, 33, and 43 in the traveling direction D1 may be smoothly formed by chamfering or the like so as to continue from the contact surfaces 22a and 32a and the first and second contact surfaces 44a and 45a.

In addition, although two grooves 23, 33, or 43 are formed at both ends of the insulating section 22, 32, or 42 in the traveling direction D1, at least one groove may be formed in the insulating section 22. When a plurality of grooves 23, 33, or 43 are formed, even if one groove is blocked by carbon to cause a conduction state, it is possible to maintain the insulating state due to another groove. That is, it is possible to achieve a redundancy as described above. Therefore, this is more preferable.

In the embodiment described above, FRP is used for the insulating sections 22, 32, and 42. However, the insulating sections 22, 32, and 42 are not limited to this.

In each of the embodiments described above, the new transportation system based on the side guide method has been described as an example. However, a center guide method or an automatic steering method without a guide is also possible.

### INDUSTRIAL APPLICABILITY

The insulating section, the power supply rail, and the orbital transportation system described above can be applied to a power supply rail for supplying electric power from the train lines located on the lateral sides with respect to a vehicle, and in particular, are suitable as an insulating section, a power supply rail, and an orbital transportation system capable of realizing reliable insulation while improving the riding quality.

### REFERENCE SIGNS LIST

1: orbital transportation system
2: vehicle
3: track
10: traveling wheel
11: guide wheel
12: pantograph (current collector)
13: guide rail
14: power supply rail
14a: chamfered portion
20: train line
21: connection plate
22: insulating section
22a: contact surface
23: groove
24: bolt
25: nut
31: power supply rail
32: insulating section
32a: contact surface
33: groove
41: power supply rail
42: insulating section
43: groove
44: first insulating portion
44a: first contact surface
45: second insulating portion
45a: second contact surface
50: power supply rail
51: pantograph
52: groove
D1: traveling direction
D2: width direction
D3: vertical direction
P: axial line

1. An insulating section that extends to a side of a vehicle and connects train lines, which are in contact with a current collector of the vehicle, to each other on a contact surface facing the vehicle,
wherein the contact surface has a groove formed from an upper edge to a lower edge in a vertical direction perpendicular to an extending direction of the insulating section, and
the groove is formed such that a cross-section in the vertical direction becomes a part of the contact surface in the vertical direction at any position in the extending direction.

2. The insulating section according to claim 1,
wherein the groove is formed so as to be inclined from one side toward the other side in the vertical direction as movement from one side toward the other side in the extending direction is made.

3. The insulating section according to claim 1,
wherein the groove is formed so as to be curved from one side toward the other side in the vertical direction as movement from one side toward the other side in the extending direction is made.

4. The insulating section according to claim 1,
wherein the contact surface has first and second contact surfaces provided with a gap therebetween in the vertical direction, and
the groove is formed at different positions in the extending direction on the first and second contact surfaces.

5. A power supply rail, comprising:
train lines in contact with a current collector of a vehicle; and
the insulating section connecting the train lines to each other according to claim 1.

6. An orbital transportation system, comprising:
the insulating section or the power supply rail according to claim 1.

7. The insulating section according to claim 2,
wherein the contact surface has first and second contact surfaces provided with a gap therebetween in the vertical direction, and
the groove is formed at different positions in the extending direction on the first and second contact surfaces.

8. The insulating section according to claim 3,
wherein the contact surface has first and second contact surfaces provided with a gap therebetween in the vertical direction, and
the groove is formed at different positions in the extending direction on the first and second contact surfaces.
